(19) United States
(12) Patent Application Publication
(10) Pub. No.: US 2007/0300265 A1
(43) Pub. Date: Dec. 27, 2007

(54) User behavior adapted electronic service guide update

(75) Inventor: Kari Karkkainen, Espoo (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/471,546

(22) Filed: Jun. 21, 2006

(51) Int. Cl. H04N 7/16

(52) U.S. Cl. 725/62; 455/3.06

(57) ABSTRACT

Provided are apparatuses and methods for transmitting and receiving information corresponding to a program or service such as Electronic Service Guide information. In one example, a user device, such as a mobile terminal, monitors usage of the user device and creates a statistical model for determining a probability of usage of the user device during periods of time. Based on the statistical model, information corresponding to the program or service may be delivered to the user device from a service provider. For example, when the probability of usage of the user device is less than a predetermined threshold value, the information corresponding to the program or service may be delivered to the user device.

### FIELD OF THE INVENTION

The invention relates generally to communications networks. More specifically, the invention relates to transmitting or receiving program or service data in a communication network.

### BACKGROUND OF THE INVENTION

Digital broadband broadcast networks enable end users to receive digital content including video, audio, data, and so forth. Using a mobile terminal, a user may receive digital content over a wireless digital broadcast network. In addition, the mobile terminal may be configured to receive Electronic Service Guide (ESG) data and updates from an ESG service provider.

However, a mobile terminal may have limited resources and may be unable to effectively receive ESG information or updates while also receiving and providing content. For example, a user may be utilizing resources by viewing a television program at a mobile terminal. While viewing the television program at the mobile terminal, effective receipt of ESG information or updates may be problematic. Specifically, ESG data receipt or updating may interfere with content provision at the mobile terminal.

Up-to-date ESG information is important to receiving and providing program or service content at a mobile terminal. If ESG data cannot be effectively received at the mobile terminal, then the ESG information received at the mobile terminal may become outdated while the user is viewing content. This problem is worsened during long periods of time of viewing content at the mobile terminal. Also, receiving ESG information and updates is more problematic when additional activities are being performed at the mobile terminal. For example, if a user is viewing and recording a program at the mobile terminal, it is even more difficult to provide updated ESG information at the mobile terminal.

Therefore, there exists a need for a method, apparatus, and system for effectively receiving program or service information at a mobile terminal while still using the mobile terminal for receiving program or service content.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example, a user device may receive Electronic Service Guide (ESG) information or data from a remote device (e.g., service provider). A usage pattern of the user device (e.g., dates/times of operation, length of time of operation, channel or service) may be monitored and a behavior model may be obtained based on the usage pattern. The ESG data may be delivered to the user device during a delivery period of time determined based on the behavior model.

In another example, a mobile terminal is provided for monitoring the usage pattern at the mobile terminal and creating a statistical model based on the usage pattern. The mobile terminal may further include a scheduler for determining a delivery period of time for receiving ESG information at the mobile terminal. In one example, the mobile terminal may transmit the statistical model to a remote device for receiving ESG information during the delivery period of time. In another example, the mobile terminal may transmit a request for the ESG information and may receive the ESG information during the delivery period of time based on the request.

In another example, a transmitting device is provided for receiving data from a remote device and transmitting ESG data to the remote device responsive to the data received from the remote device. In one example, the data received from the remote device includes a delivery time period during which ESG data may be transmitted to the remote device. In another example, the data received from the remote device includes a statistical model including a probability of the remote device being in use during a period of time.

In another example, a computer-readable medium is provided including computer-executable instructions for determining a behavior model and a statistical model for determining a delivery period of time for delivering information corresponding to a program or service (e.g., ESG data) to a user device. The ESG data is delivered to the user device during the delivery period of time as determined.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a suitable digital broadband broadcast system 102 in which one or more illustrative embodiments of the invention may be implemented.

FIG. 2 illustrates an example of a mobile device in accordance with an aspect of the present invention.

FIG. 3 is a diagram of an example transport object in accordance with at least one aspect of the present invention.

FIG. 4 illustrates an example of transmitting a plurality of single Transport Objects in accordance with at least one aspect of the present invention.

FIG. 5 illustrates an example of a behavior module in accordance with an aspect of the present invention.

FIG. 6A illustrates an example of a statistical model based on usage patterns of a mobile terminal detected over a period of time in accordance with an aspect of the present invention.

FIG. 6B illustrates an example of a statistical model including probability information of usage of a mobile terminal over a period of time in accordance with an aspect of the present invention.

FIG. 7 is a flowchart illustrating an example of a user device receiving ESG data in accordance with an aspect of the present invention.

FIG. 8 is a partial block diagram illustrating an example of a user device for receiving ESG data from a service provider in accordance with an aspect of the present invention.

FIG. 9 is a partial block diagram illustrating another example of a user device for receiving ESG data from a service provider in accordance with an aspect of the present invention.

FIG. 10 is a partial block diagram illustrating an example of a server of a service provider in accordance with an aspect of the present invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

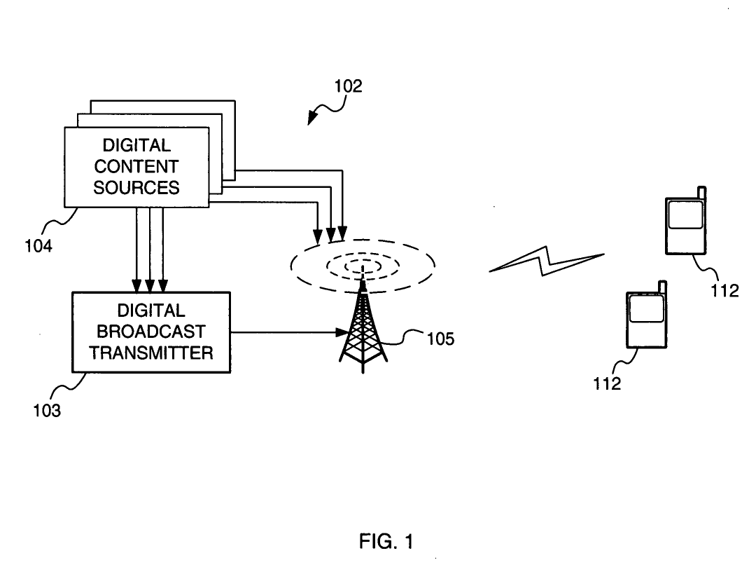

FIG. 1, one aspect of the invention, illustrates a suitable digital broadband broadcast system 102 in which one or more illustrative embodiments of the invention may be implemented. Systems such as the one illustrated here may utilize an audio, video, radio and/or television digital broadband broadcast technology, for example Digital Video Broadcast-Handheld (DVB-H) or next generation DVB-H networks such as DVB-H2. Examples of other digital broadcast standards which digital broadband broadcast system 102 may utilize include Digital Video Broadcast-Terrestrial (DVB-T), Integrated Services Digital Broadcasting-Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Satellite Digital Multimedia Broadcasting (S-DMB), Forward Link Only (FLO), Digital Audio Broadcasting (DAB), and Digital Radio Mondiale (DRM). Other digital broadcasting standards and techniques, now known or later developed, may also be used. An aspect of the invention is also applicable to other multicarrier digital broadcast systems such as, for example, T-DAB, T/S-DMB, ISDB-T, and ATSC, proprietary systems such as Qualcomm MediaFLO/FLO, and non-traditional systems such 3GPP MBMS (Multimedia Broadcast/Multicast Services) and 3GPP2 BCMCS (Broadcast/Multicast Service).

Digital content may be created and/or provided by digital content sources 104 and may include video signals, audio signals, data, and so forth. Digital content sources 104 may provide content to digital broadcast transmitter 103 in the form of digital packets, e.g., Internet Protocol (IP) packets. A group of related IP packets sharing a certain unique IP address or other source identifier is sometimes described as an IP stream. Digital broadcast transmitter 103 may receive, process, and forward for transmission multiple IP streams from multiple digital content sources 104. The processed digital content may then be passed to digital broadcast tower 105 (or other physical transmission component) for wireless transmission. Ultimately, mobile terminals or devices 112 may selectively receive and consume digital content originating from digital content sources 104. In one or more arrangements, mobile terminals or devices 112 may further send and/or receive data directly to and from the digital content sources 104 through one or more wireless telecommunication back channels. That is, transmissions might not need to initially go through the digital broadcast transmitter 103. For example, the back channels may be used by content sources 104 to update ESG data in the mobile devices 112.

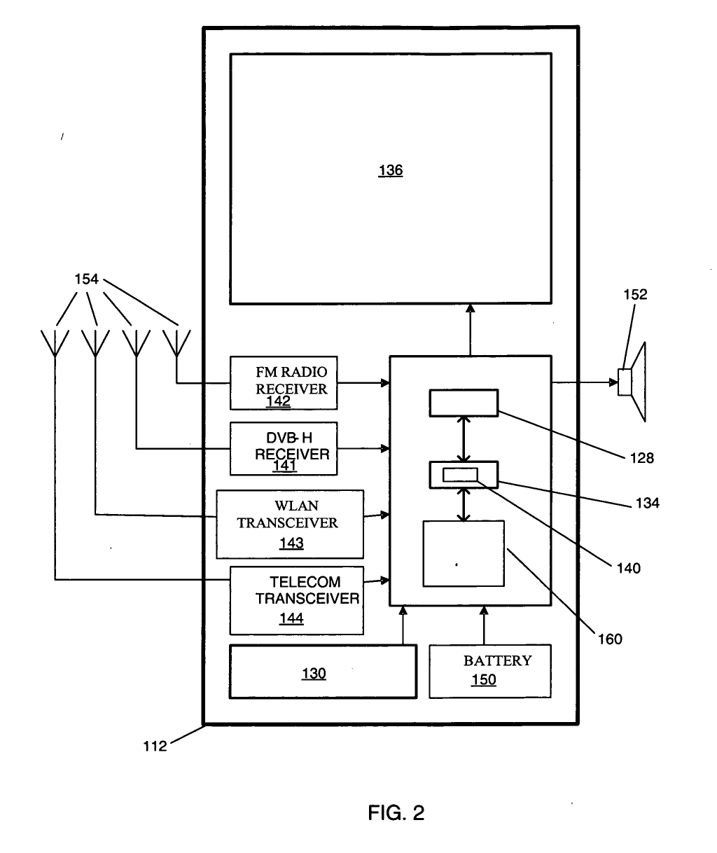

As shown in FIG. 2, according one aspect, the mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, one or more arrow keys, joy-stick, data glove, mouse, roller ball, touch screen, or the like. The mobile device 112 may be a mobile phone, a PDA, a mobile communication device, an audio/video player and/or recorder, a television receiver, a radio receiver, a GPS device, a personal computer, a set-top box (STB) or any combination of the aforementioned.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital audio, video, radio and/or television broadband broadcast transmissions that are based, for example, on the Digital Video Broadcast (DVB) standard, such as DVB-H, DVB-H2, or DVB-MHP, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In addition, mobile device 112 may include a behavior module 160. The behavior module 160 may monitor usage of the mobile device 112 and may determine a behavior model based on the general usage of the mobile device 112 and usage of audio, video, radio and/or television content in the mobile device 112. For example, a user may use the mobile device 112 to watch mobile television programs on the display 136 at a particular day or time or a particular channel.

The behavior module 160 may detect specific information of the usage of the mobile device 112. Based on the detected usage information, the behavior module 160 may apply statistical analysis to determine a usage model which may be used to determine reception of information corresponding to a program or service such as an Electronic Service Guide (ESG). For example, the time of reception, the length of time of reception, and/or the channel of reception of program or service information may be determined in the behavior module 160 based on usage patterns. The behavior module may be implemented in hardware, software, or a combination of the two. Behavior module 160 may further determine a schedule for updating ESG data based on a user's behavior and selections of TV channels included in the ESG. For example, statistics associated with ESG usage and channel selection may be determined from a user's behavior through the behavior module 160. The behavior module 160 may identify particular channels are only accessed at certain times or that those channels are accessed more frequently than others. In response, the behavior module may update ESG information more frequently only for those particular channels. Channel selection and ESG usage statistics and behavior may also be used in a variety of other ways to enhance efficiency and effectiveness of ESG updating and use.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), or DVB-Terrestrial (DVB-T). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing entails sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

In addition, ESGs may be used to provide program or service related information. Generally, an ESG enables a terminal to communicate what services are available to end users and how the services may be accessed. The ESG includes independently existing pieces of ESG fragments. Traditionally, ESG fragments include XML documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data including the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG).

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetized data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, is incorporated into the TS. This enables a receiver device to correctly process the data contained within the TS.

As stated above, the ESG fragments may be transported by IPDC over a network, such as for example, DVB-H to destination devices. The DVB-H may include, for example, separate audio, video and data streams. The destination device must then again determine the ordering of the ESG fragments and assemble them into useful information.

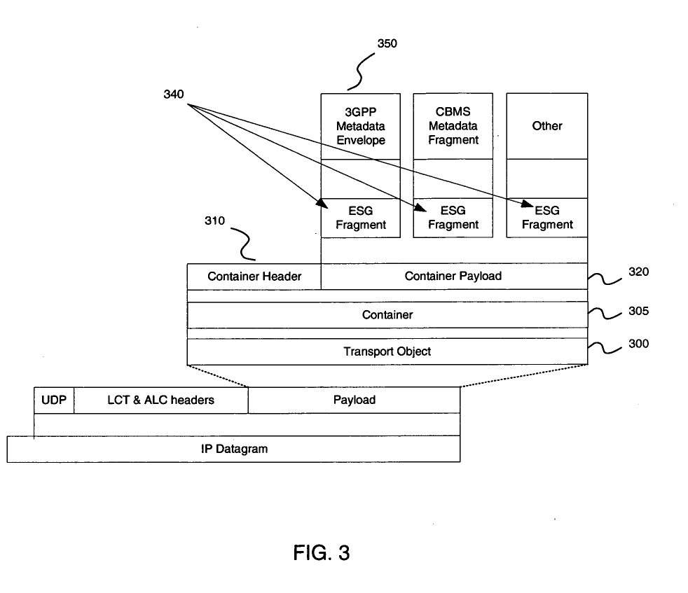

ESG fragments may be delivered in a transport object which may transport ESG information in a container. Thus, ESG fragments may be placed in a container that may be delivered in its own transport object. The container may further include a container header and a container payload, for example, in which the container header may provide information on where each container is located within the transport object. In one example, the transport object may contain a single container or a plurality of containers, each container including at least one ESG fragment. FIG. 3 is a diagram of an example transport object in accordance with at least one aspect of the present invention. As illustrated in the example of FIG. 3, a transport object 300 may comprise a container that may include a container header 310 and a container payload 320. In one example, the container header 310 and the container payload 320 are incorporated into a single container 305 which may be incorporated into a single transport object 300 so that the container header 310 need not be recombined with information regarding where each container is located within different transported objects. Alternatively, the transport object 300 may contain a plurality of containers and a container may contain any number of ESG fragments 340. The container header 310 may contain information associated with a corresponding ESG fragment such as, for example, information regarding the container header 310 itself and/or the container payload 320.

In the example illustrated in FIG. 3, the ESG fragment 340 is contained in the container payload 320. The container header 310 may contain descriptors for identifying and describing ESG fragments in the corresponding container payload 320. Thus, the characteristics of the ESG fragment may be identified, such as but not limited to the position of the ESG fragment in the transport object 300 or the length of each contained ESG fragment 340. For example, in one embodiment, a field specifies where the particular ESG begins within the container payload 320 by providing, for example, an offset value, start and end points, or the like. In other embodiments, metadata 350 may be associated with the individual ESG fragments 340, located within or proximate to the header 310, descriptor entries, an ESG fragment 340 or a mixture thereof. In one exemplary embodiment, the association of a 3GPP metadata envelope with an ESG fragment 340 may substitute for, or negate the need of additional metadata to be located in the header 310 in relation to that particular ESG fragment.

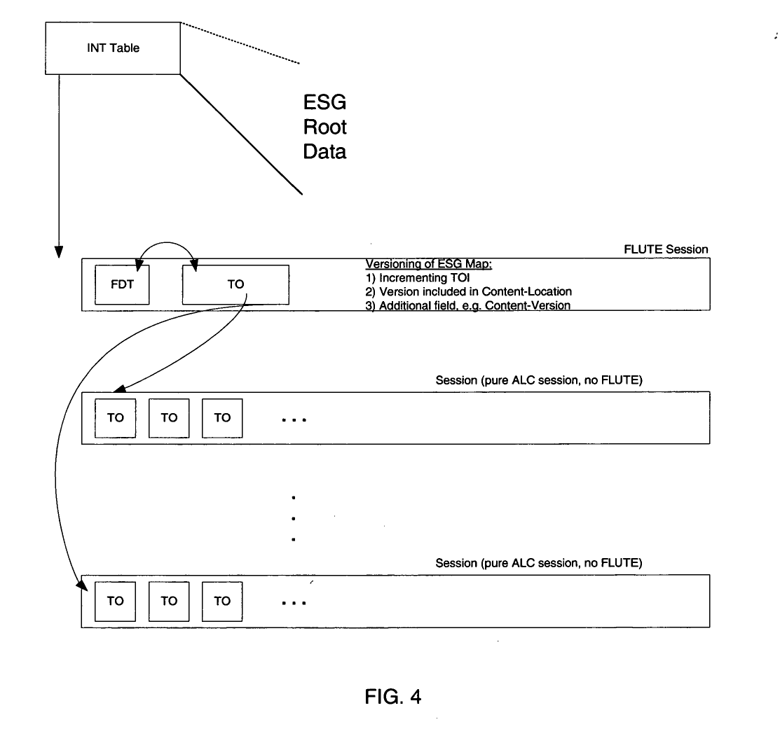

FIG. 4, according to one aspect of the invention, illustrates an example of transmitting a plurality of single Transport Objects. As illustrated in FIG. 4, the Transport Objects (TO) of the current invention may be carried in, for example, FLUTE (File Delivery over Unidirectional Transport) sessions, or a pure Asynchronous Layered Coding (ALC) session. In the example of FIG. 4, the ESG Root Channel data, such as IP Address, port number and Transport Session Identifier (TSI), are announced in the IP/MAC Notification Table (INT Table) which may be, for example, carried in the SI/PSI stream in DVB-H as one of the SI tables of DVB-H. The FLUTE session of the ESG Root Channel comprises a File Delivery Table (FDT) of the session and one or more Transport Objects (TO). These Transport Objects that may be delivered in announcement carousels contain mapping between the different parts of ESGs and access parameters to the different ESG methods in which the ESG data is transmitted.

As described above, the Electronic Service Guide (ESG) fragments may provide information regarding what programs or services are available to end users, provide information on how the programs/services may be accessed, or describe one or several aspects of currently available (or future) service or broadcast program. Hence, data provided in the ESG to the mobile terminal may be important in proper transmission of program or service content. In one example, ESG data may be received during certain designated periods of time of use of the mobile terminal. The periods of time for receiving ESG information or updated ESG information may be determined based on usage of the mobile terminal.

In one example, a mobile terminal may contain a user behavior module for determining user behavior with respect to use of the mobile terminal. A user may utilize the mobile terminal in a variety of activities in a variety of usage patterns. For example, the user may power on the mobile terminal for an activity for a certain period of time or for certain activities. One example would be a user viewing a television program at a particular day and/or time on the mobile terminal for a certain period of time. The programs viewed on the mobile terminal may be on certain channels, on certain days of the week or at certain hours of the day and may play for a certain length of time. Any of this information may be utilized in determining a behavior pattern of the user and further determining a time period in which to transmit information pertaining to programs or services.

Also, a user may receive programs or services at certain times/days and programs or services at certain other times/days. Any aspect of the received content at the mobile terminal may be obtained to determine usage patterns at the mobile terminal. Based on the behavior pattern information, the user behavior module may determine parameters for improved transmission of information such as ESG information pertaining to a program or service. For example, the user behavior module may determine a delivery time period that would decrease interference with transmission or reception of program or service content. Also, the user behavior module may determine any other aspect of delivery of information at the mobile terminal. For example, the behavior module may determine a mode or method of delivery for improving the delivery of the information. Non-limiting examples of this would be a determination of delivery of ESG information via a wireless telecom network or a digital TV network such as IPDC/DVB-H.

Alternatively or additionally, a mobile terminal's environment may play a role in determining when or how data is received and/or transmitted. For example, the location of a user's mobile terminal may also be tracked to further refine a behavior model. For example, a user may have a summer house at a location where mobile TV service is unavailable or where the user does not view mobile TV content. In such a situation, ESG data might not be downloaded to the user's mobile terminal when the user is at the summer house location based on this behavior information. According to yet another aspect, a user's network resources may be evaluated to determine a best time to download updates and other information. Network resources may relate to bandwidth, speed and the like of a network system. Thus, if a user's mobile terminal is at work where a WLAN is available, ESG data may be updated at work, rather than at home, to take advantage of the speed and bandwidth of the WLAN.

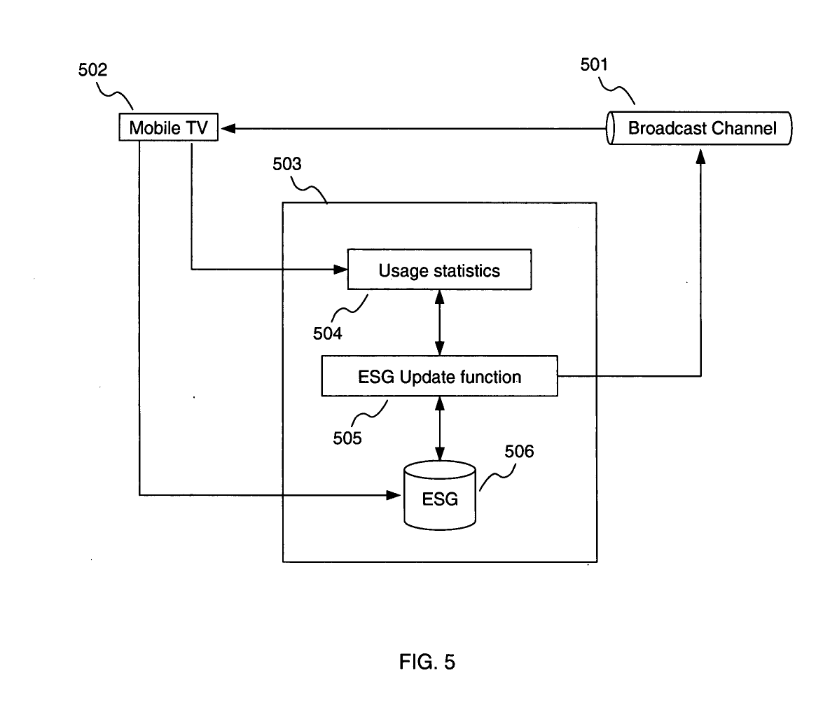

FIG. 5, according to one aspect of the invention, illustrates an example of a behavior module. In this example, a program or service is transmitted via a broadcast channel 501 to a mobile terminal. For example, a mobile television broadcast may be transmitted over the broadcast channel 501 to be received at the mobile TV 502. The mobile TV 502 may further include a behavior module 503 that detects usage patterns of the user of the mobile TV 502 and determines the method and/or mode of transmission of information pertaining to program or service transmission, such as program or service information in an ESG fragment.

The behavior module 503 in this example includes usage statistics module 504 for determining statistics for indicating a data delivery time during which data, such as ESG data may be received. Also, the statistics module 504 may further determine a method or mode of transmission of ESG information based on the usage of the mobile TV 502. Information on the usage of the mobile TV 502 for viewing the television programs at the particular times/days may be transmitted to the usage statistics module 504 of the behavior module 503. The usage statistics module 504 may be located within the mobile TV 502 or may be located separate from the mobile TV 502 (as FIG. 5 illustrates) and receives the usage information from the mobile TV 502. Based on the received usage information, the usage statistics module 504 creates a statistical model for adapting the usage pattern to reception of ESG data.

As FIG. 5 illustrates, ESG data may be transmitted over the broadcast channel 501 to the mobile TV 502. However, if television program content is also being transmitted over the broadcast channel 501 to the mobile TV 502 at the same time, there may be interference between the transmission of the ESG data and the transmission of the television program content at the mobile TV 502. Hence, the ESG data may be transmitted over the broadcast channel 501 to the mobile TV 502 at times and under certain modalities that are determined based on the usage statistics module 504. In this example, automatic ESG updates may be scheduled based on the statistical model generated by the usage statistics module 504.

The statistical model may be transmitted from the usage statistics module 504 to an ESG update function module 505. The ESG update function module 505 schedules ESG updates based on the statistical model received from the usage statistics module 504. For example, the ESG update function module 505 may determine times for transmission or reception of ESG update information that do not coincide with times for transmission of television program content. Alternatively, ESG update function module 505 may schedule ESG updates without regard to statistical models and/or other information determined by the usage statistics module 504. The ESG update scheduling information may be transmitted from the ESG update function module 505 via the broadcast channel 501 back to the service provider. The service provider then provides ESG update information to the mobile TV 502 according to the scheduling information received from the ESG update function module 505. In one or more arrangements, the usage statistics module 504 may create the statistical model based on usage patterns of the mobile TV 502 and send the statistical model to a server of the service provider via the broadcast channel 501. The server receives the statistical model and transmits ESG update information according to the statistical model.

Based on the statistical, scheduling or delivery information received from the behavior module 503, the server or service provider may transmit ESG update information via the broadcast channel 501 to the mobile TV 502. The ESG update information may be stored in a database 506 in the mobile TV 502. Alternatively, the database 506 may be located separate from the mobile TV 502. The ESG information stored in the database 506 may be updated with the received ESG update information from the server. Hence, the reception of ESG update information may be scheduled based on usage patterns of the mobile TV 502, statistical information derived from the usage patterns of the mobile TV 502, and/or scheduling information based on either the statistical information or usage patterns of the mobile TV 502.

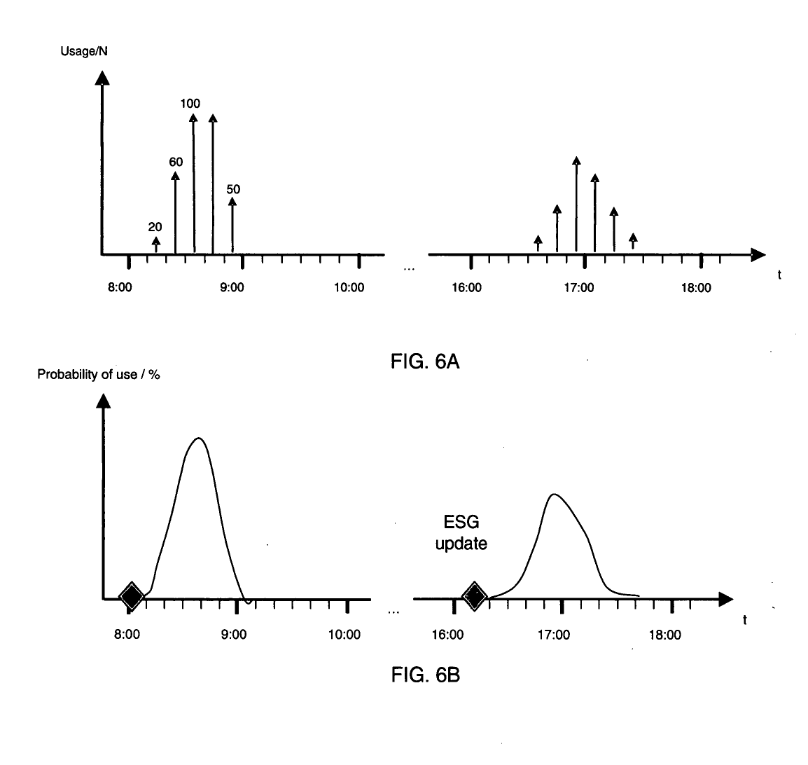

FIGS. 6A and 6B, according to one or more aspects of the invention, illustrate an example of a statistical model based on usage patterns of a mobile terminal detected over a period of time. FIG. 6A illustrates a pattern of usage of the mobile terminal from 8:00 AM to 6:00 PM. Each incident of usage of the mobile terminal is detected. The time of usage of the mobile terminal is also determined and the results are described in the graphs as illustrated in FIG. 6A. As FIG. 6A illustrates, it may be determined that the mobile terminal is more heavily used between about 8:00 AM-9:00 AM and from approximately 4:30 PM-5:30 PM. Based on this detected usage pattern, the probability of usage of the mobile terminal at any given time is determined. FIG. 6B illustrates a statistical model for the probability of usage of the mobile terminal over a period of time based on the detected usage patterns. As FIG. 6B illustrates, the probability of the mobile terminal being in use peaks during the 8 AM-9 AM time period and from about 4:30 PM-5:30 PM.

In this example, transmission of ESG data may be scheduled during periods of time in which the probability of the mobile terminal being in use is low such that scheduling of transmission of ESG data during times in which the probability of the mobile terminal being in use is high may be avoided (e.g., during the 8-9 AM or 4:30-5:30 PM time periods). In the example illustrated in FIG. 6B, the time for transmission of ESG data is determined based on the behavior and/or statistical model.

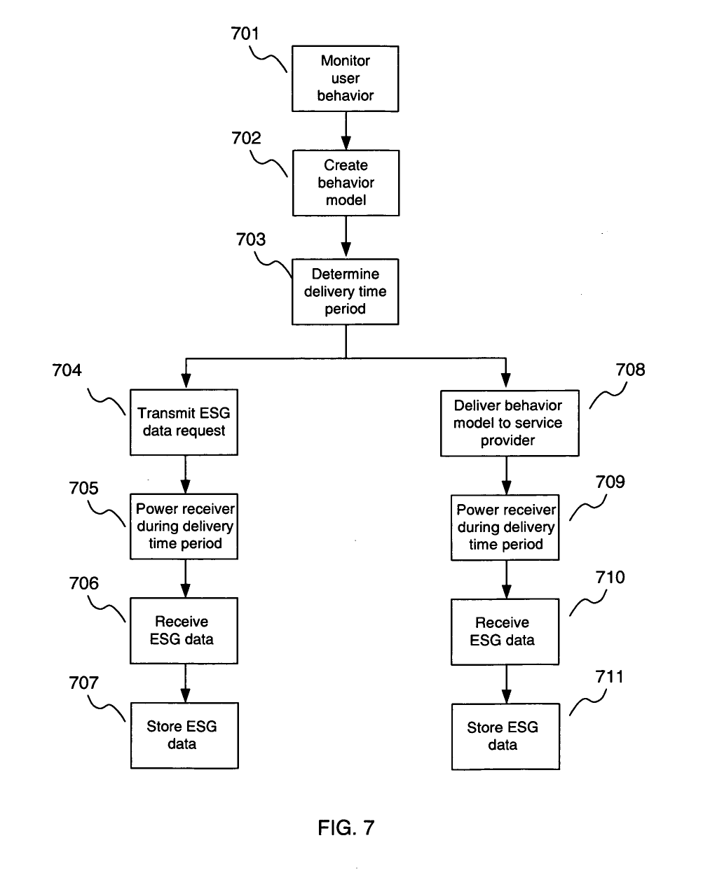

FIG. 7, according to one or more aspects of the invention, is a flowchart illustrating an example of a user device receiving ESG data based on detected behavior patterns. FIG. 7 further illustrates an example of scheduling content delivery for an ESG in a user device. The user device may be any electronic device for receiving a program or service. For example, the user device may include a mobile television device, a mobile phone, a mobile communication device, a digital audio device, a digital video device, a digital camera device, a digital camcorder device, a digital radio device, a GSP device, to name a few.

In STEP 701, user behavior is monitored. For example, times or days when a user device is activated or length of time the user device is activated may be monitored. Also, the channel used by a service or program received may also be monitored. Any information pertaining to user behavior at a user device may be monitored in STEP 701. Based on the monitored behavior of the user, a behavior model may be created (STEP 702). The behavior model may provide information pertaining to the usage patterns of the user device. Based on the behavior model, delivery time periods may be determined (STEP 703) for delivery of data to the user device. For example, the delivery time periods may describe periods of time which are less likely that the user device is in use such that the user device may receive transmitted data during the periods of times.

In one example, the user device may transmit a request to a service provider or a server of a service provider to request program or service data such as ESG fragment data corresponding to a program or service of interest (STEP 704). Also, optionally, the user device may power on during the time period determined in STEP 703 (STEP 705). Thus, the user device may be powered on during the time period such that the user device may receive data, such as ESG fragment information corresponding to a program or service during the time period (STEP 706). In addition, the user device may store the data (e.g., ESG data) in STEP 707. The received ESG data may be updated ESG data such that storing the updated ESG data may update any ESG data already stored in the storage.

In another example, usage patterns are monitored at a user device and a behavior model is created based on the monitored usage patterns as described above (STEPS 701 and 702). In addition, a delivery time period for the delivery of information corresponding to a program or service may also be determined based on the behavior model (STEP 703). In this example, the behavior model may be transmitted from the user device to a service provider or a server of a service provider (STEP 708). Also, the behavior model transmitted to the service provide or the service of the service provider may include at least one delivery time period determined based on the behavior model. In STEP 709, the user device may be powered on during the delivery period of time. In one example, the service provider or server of the service provider may transmit a control signal to the user device for turning on the user device. In another example, the user device may turn on in STEP 709 responsive to instructions in the behavior model at the user device. When the user device is turned on during the delivery time period, the user device may receive data corresponding to the program or service (e.g., the ESG data or data fragment). The ESG data, including any updated ESG data, may further be stored at the user device.

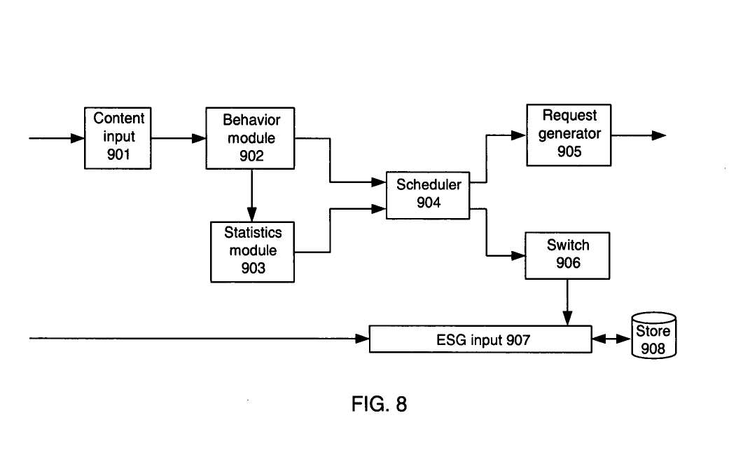

FIG. 8, according to one or more aspects of the invention, is a partial block diagram illustrating an example of a user device for receiving ESG data from a service provider. The receiver may include a content input 901 for receiving program or service content. For example, the user device may be a mobile television device and the content input 901 of the mobile television device may receive a television program at the content input 901. However, the present invention is not so limited as any user device such as a communication device, mobile telephone, etc. may be used.

The user device may further include a behavior module 902 for determining usage patterns of the user device. The program or service content may be received at the content input 901 and the user device may determine times, periods of times, channels, etc. pertaining to the received program or service content. The user device may further be powered on during certain time periods corresponding to broadcast times of a particular television program (or programs). The behavior module 902 may collect the usage patterns and provide the information to a statistics module 903. The statistics module 903 receives the usage patterns and create a statistical model based on the usage patterns from the behavior module 902. The statistical model from the statistics module 903 provides information on the probability of the user device being activated and in use during certain periods of times and/or the probability of the user device being inactive during certain other periods of time.

The behavior usage patterns and/or the statistical model from the statistic module 903 may be processed in a scheduler 904. The scheduler 904 receives the behavior usage patterns and/or the statistical model from the behavior module 902 and statistics module 903, respectively and may determine a time period for delivery of information corresponding to a program or service (e.g., ESG data corresponding to a program or service). The information from the scheduler 904 may further include a control signal for activating a switch 906 at the user device. When the switch 906 is activated at the user device, the user device is activated to receive data input such as ESG data via the ESG input 907.

Based on the delivery time period determined by the scheduler 904, a request generator 905 may generate a request for ESG data corresponding to a program or service of interest. The request generator 905 may further transmit the request at a time based on the delivery time period determined by the scheduler 904. For example, the request generator 905 may generate and transmit the request for ESG data to the service provider or a server of the service provider during the delivery time period determined by the scheduler 904.

The service provider or server of the service provider may transmit the requested information (e.g., ESG data corresponding to a program or service of interest) to the user device, which may be received by the ESG input 907. Further, the ESG data, including any updated ESG data, received at the ESG input 907 may further be stored in storage 908.

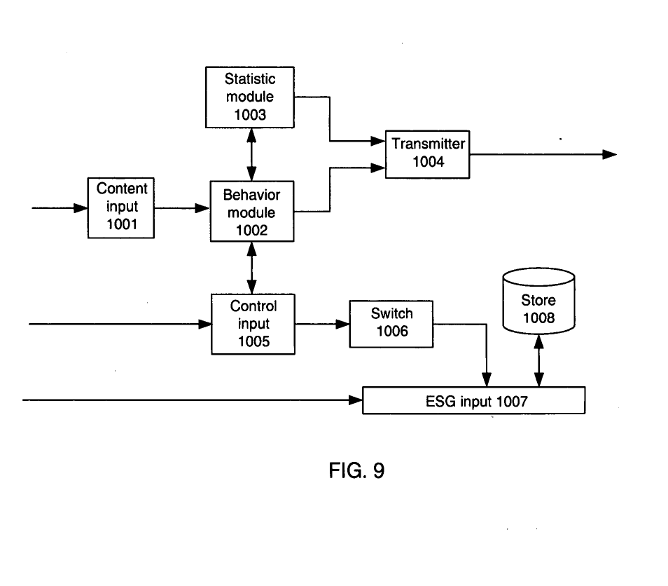

FIG. 9, according to one or more aspects of the invention, is a partial block diagram illustrating another example of a user device for receiving ESG data from a service provider. The user device illustrated in FIG. 9 is similar to the user device illustrated in FIG. 8, however, the user device illustrated in FIG. 9 comprises a transmitter 1004 for transmitting a statistical model to a remote device such as a service provider. As FIG. 9 illustrates, the user device includes a content input 1001 for receiving program or service content. The user device in FIG. 9, as in the user device of FIG. 8, may schedule receipt of program or information corresponding to a program or service, the length of time the program or service is received, the data and time of receipt of the program or service, or the channel over which the information is received based on a usage pattern of the user device. The usage patterns may further be processed at the statistics module 1003 to create a statistical model describing the probability of the user device being in use or activated at a particular time or time period. In addition, the statistical model may provide information pertaining to the mode of transmission, channel of transmission, etc.

However, in the user device illustrated in FIG. 9, the behavior model and/or statistical model may be transmitted via a transmitter 1004 to a service provider or a server of a service provider, which may receive the information and determine data delivery time periods based on the behavior and/or statistical models received. At a time that is determined based on the delivery time periods (e.g., a time within the delivery time period), the service provider or server of the service provider may transmit a control signal to the user device. The control signal may be received at a control input 1005 which may cause a switch 1006 to be activated. Activation of the switch 1006 causes the ESG input 1007 to be activated, which may receive ESG data or ESG update data from a remote source (e.g., the service provider).

Alternatively, the behavior module 1002 may create a behavior model, which may control the activation of the switch 1006 via the control input 1005. For example, the behavior model may describe time periods of time in which the user device is more likely to be activated and certain other time periods in which the user device is more likely not to be in use. The control input 1005 may receive this information and, based on this information, may control activation of the ESG input 1007 of the user device (e.g., power on the user device) during the delivery time period. Alternatively, the statistic module 1003 may create the statistical model which may also control the switch to activate the user device via the ESG input 1007 to be activated during the delivery time period. In addition, the ESG data received, including any ESG update information, may be stored in storage 1008.

Also, in another example, the user device may transmit the behavior usage pattern and/or statistical model to a service provider or server of a service provider. The service provider (or server) may determine a delivery time period based on information received from the user device. During the delivery time period, the service provider may transmit information (e.g., including ESG data or ESG update information) to the user device.

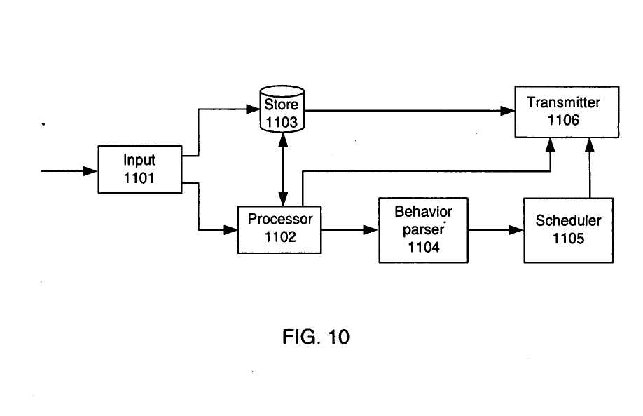

FIG. 10, according to one or more aspects of the invention, is a partial block diagram illustrating an example of a server of a service provider. The server includes an input 1101 for receiving a behavior usage pattern or model and/or a statistical model from a user device. Thus, the server receives, for example, usage patterns of the user device (i.e., times during which the user device may be activated or not activated or receiving program or service content) or a statistical model for providing probability information of the user device. For example, the statistical model may provide a probability of the user device being activated at a particular time period or not being activated and not receiving program or service content during a time period.

The server may further include a processor 1102 for processing the information received from the user device (e.g., the statistical model). Based on the information received, a behavior parser 1104 in the server may identify usage patterns or probabilities pertaining to user behavior at the user device as described. The server may further include a scheduler 1105 that, based on input from the behavior parser 1104 (i.e., usage patterns or probability information), may determine delivery time periods during which time data and information corresponding to a program or service (e.g., ESG data or ESG update information) may be transmitted. Based on this information a transmitter 1106 of the server may transmit the data during the delivery time period. In addition, the behavior model or the statistical model may be stored in storage 1103.

The present invention also relates to a computer-readable medium having computer-executable instructions for performing any of the methods herein. Further the computer-readable medium may be implemented on any of the devices described herein.

The embodiments herein include any feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques.

I claim:

1. A method comprising:
monitoring a usage pattern of a user device;
obtaining a behavior model based on the monitoring;
determining one or more delivery time periods based on the obtained behavior model;
receiving program information during the one or more determined delivery time periods at the user device.

2. The method of claim 1, wherein the program information includes at least one of an Electronic Service Guide (ESG) and an Electronic Program Guide (EPG),

3. The method of claim 1, wherein receiving the program information includes receiving one or more fragments of the program information.

4. The method of claim 1, wherein the monitoring includes monitoring one of a time of usage of the user device, a length of time of usage of the user device, a channel used by the user device, and a service used by the user device.

5. The method of claim 1, wherein the obtaining includes creating the behavior model based on the usage pattern of the user device and creating a statistical model based on the behavior model, the statistical model including a probability of the user device being activated during a period of time.

6. The method of claim 5, wherein the probability of the user device being activated during a period of time is lower than a predetermined level and wherein the determining step includes setting the one or more delivery time periods equal to the period of time.

7. The method of claim 1, further comprising transmitting a request for the program information to a server during the one or more delivery time periods.

8. The method of claim 7, wherein the request includes at least one of the one or more delivery time periods, a latest update, or a delivery method.

9. The method of claim 8, wherein the request includes the delivery method, the delivery method including one of a wireless telecommunications network and a digital broadcasting network.

10. The method of claim 9, wherein the request includes a digital TV network including IPDC/DVB-H.

11. The method of claim 1, further comprising activating the user device during the one or more delivery time periods.

12. The method of claim 1, further comprising transmitting the behavior model to a remote device.

13. The method of claim 12, wherein the behavior model comprises one of the one or more delivery time periods, an ESG update, and a delivery method for delivering the ESG data to the user device.

14. The method of claim 12 further comprising after transmitting the behavior model to the remote device, receiving a command from the remote device to turn on the user device.

15. The method of claim 12, further comprising turning on the user device during the one or more delivery time periods responsive to receiving the command.

16. A mobile device, comprising
a behavior module for monitoring a usage pattern of the mobile device;
a statistic module for creating a statistical model based on the usage pattern of the mobile device;
a scheduler for determining one or more delivery periods of time based on the statistical model for receiving program information at the mobile device; and
an input device for receiving the program information during the one or more delivery periods of time.

17. The mobile device of claim 16, further comprising an output device for transmitting a request for the program information to a remote device, the input device receiving the program information from the remote device responsive to the request.

18. The mobile device of claim 17, wherein the request includes one of the one or more delivery periods of time, a latest update, and a delivery method.

19. The mobile device of claim 16, further comprising an output device for transmitting the statistical model to a remote device, the statistical model including one of the one or more delivery time periods, a latest program information update, and a delivery method.

20. The mobile device of claim 17 wherein the statistical model includes the delivery time, the input device receiving the program information from the remote device responsive to transmission of the statistical model.

21. The mobile device of claim 16, further comprising a storage for storing the received program information.

22. A transmitting device in a communication network comprising:
an input device for receiving data from a user device;
a scheduler for determining one or more delivery time periods based on the data from the user device; and
a transmitter for transmitting program information to the user device during the one or more delivery time periods.

23. The device of claim 22, wherein the data received from the mobile device includes a statistical model based on a usage pattern of the mobile device.

24. The device of claim 23, wherein the statistical model comprises a probability of the mobile device being in use during a period of time.

25. The device of claim 24, wherein the scheduler determines the one or more delivery time periods based on one or more periods of time during which the probability of the mobile device being in use is less than a predetermined threshold value.

26. The device of claim 22, wherein the data received from the mobile device includes a request for the program information.

27. The device of claim 25, wherein the request comprises one of the one or more delivery time periods, a latest program information update, and a program information delivery method.

28. The device of claim 25, wherein the request comprises the one or more delivery time periods and wherein the scheduler determines the one or more delivery time periods for transmitting the program information to be the one or more delivery time periods received from the mobile device.

29. A computer-readable medium having computer-executable code for performing the following steps:
determining a behavior model of a user device based on a usage pattern of the user device;
determining a statistical model based on the behavior model, the statistical model including a probability of the user device being in use during a period of time;
receiving ESG data at the user device during the period of time.
